(19) United States
(12) Patent Application Publication
(10) Pub. No.: US 2009/0184231 A1
(43) Pub. Date: Jul. 23, 2009

(54) CONCRETE EDGE FORMING SYSTEM

(76) Inventor: Fred Garrett, New Wilmington, PA (US)

Correspondence Address: BARLOW, JOSEPHS & HOLMES, LTD., 101 DYER STREET, 5TH FLOOR, PROVIDENCE, RI, 02903, US

(21) Appl. No.: 12/018,231

(22) Filed: Jan. 23, 2008

(51) Int. Cl. B29C 33/42

(52) U.S. Cl. 249/187.1

(57) ABSTRACT

A concrete forming system is provided for use in connection with conventional concrete forming materials in order to impart a clean finished appearance to the exposed face and lower exposed edge of a cantilevered concrete slab. The edge form is an extruded forming component that is installed into a concrete edge form by hanging the extrusion over the edge forming material. The interior surface of the extrusion is smooth and includes a radius that extends downwardly and outwardly from the bottom edge thereof. The smooth vertical face of the extrusion and the radiused lower edge cover the inner face of the traditional slab edge form creating a new exposed profile against which the concrete will be placed. When the edge form is removed a smooth edge face and a radiused bottom edge are revealed.

### BACKGROUND OF THE INVENTION

The present invention relates generally to a forming system for use in monolithic concrete installations. More specifically, the present invention relates to an edge forming system for use in connection with shaping the lower exposed edge of a concrete slab.

Concrete is a popular material that is utilized in forming patios, porches and deck surfaces. Concrete is a versatile material that is used in construction and is popular because it can be formed into virtually any shape desired by the end user. In this regard, generally the concrete is installed in a wet, flowable state that must be contained by form panels, which serve to retain the concrete in the desired shape until it hardens sufficiently such that it retains the shape imparted by the form panels. When installing concrete, the installer first arranges the form panels into the desired configuration. The form panels are all affixed to one another and are generally braced into their installed position to prevent their movement during the placement and curing of the concrete. With the form panels installed, the installer then pours the wet flowable concrete into the void formed between the form panels and vibrates the concrete so that all of the voids and air pockets are removed, effectively consolidating the concrete and causing it conform to the profile of the form panels that contain it. In the case of wall construction, such as those used in building foundations, the only remaining step is the removal of the form panels once the concrete has hardened.

In contrast, when placing a concrete slab that will serve as a patio or deck, the top exposed surface of the concrete must be finished before the concrete has hardened. In these applications, the surface may be troweled to a smooth finish, broom finished to roughen the surface of the slab and enhance traction or stamped to impart a decorative finish giving the appearance of set stone. As can be appreciated, should the building design intend that the surfaces of the concrete remain exposed to view in the finished product, it is desirable that the finishes have a quality appearance. In the case of slabs as described above, the exposed top surface can be easily finished during the placement of the slab.

The difficulty arises when the surfaces that will be exposed in the finished product are not accessible during the concrete placement process because they are covered by the forming panels used to contain the flowable concrete. This problem is further compounded in applications such as porches or pool decks wherein the slab is placed over the top of a wall such that a portion of the slab edge cantilevers over the wall. In these applications, it is desirable that not only the edge face of the slab have a smooth, finished appearance but also that the bottom edge of the slab have a nice rounded, finished edge as well. As depicted at FIG. 1, the prior art technique used in such situations provides for a bottom form 2 and an edge face form 4 to be built out of wood and affixed to the vertical wall onto which the slab 6 is to be placed. However, when using wood for these applications, the grain of the wood can be seen in the finish of the concrete 8. Further, the bottom edge 10 of the slab 6 tends to be sharp and a little jagged giving the edge 10 of the slab 6 an unfinished appearance. Generally, to improve the appearance in these cases, an additional step is taken wherein the edge is refinished with a concrete slurry after the form is removed in a process called rubbing.

In the context of forming the slab edge for a pool deck, the currently preferred method involves the use of a disposable mold form is bonded to the vertical wall. In these applications, it is common to include a tie wire that fits through the disposable mold form and is attached to an anchor, such as a nail driven into the concrete sidewall. The tie wire typically includes a weakened portion such as a notch that enables the tie wire to be broken and removed from the coping once the coping has at least partially cured. The problem with this approach is that the tie wire is sometimes not removed until the coping has entirely cured, at which point the coping often tends to bind to the tie wire and thereby prevent it from being removed from the coping. If a portion of the tie wire remains near the surface of the coping, the remnant will corrode and expand, which in turn spalls the surface of the coping. Further, since these edge forms tend to be foam or urethane materials they are fragile. Excessive vibration of the concrete as it is placed can cause these forms to fail, while insufficient vibrations leaves a rough appearing concrete finish. As a result, in this application as well, rubbing is often required to achieve the desired finish.

Another prior art solution provides coping structures which include a plurality of facing sections, generally formed of extruded aluminum, that are secured together and to a coping support member in the form of a cap for the upper edges of the sides of a pool wall. The coping sections generally are in endwise abutting relation to each other and are secured together and to the support member by bolts or screws or welding. The edging however is then left in place as the finished product. Often this approach is regarded as the cheap approach since the appearance of the finished product does not have a high-end look and feel.

Further in all of the prior art solutions, the materials used in creating the slab edge are not reusable. The wood form panels, once removed are generally broken and soiled by concrete. Similarly, the urethane or foam edge forms are simply too fragile to be removed in one piece. Finally, the aluminum copings are required to be left in place.

There is therefore a need for a concrete edge forming system that imparts a smooth and clean finish to the face of an exposed concrete slab while also providing a radius for its lower edge. Further, there is a need for a concrete edge forming system that imparts a smooth clean finish to the exposed face and the bottom, exposed edge of a cantilevered concrete slab. Finally, there is a need for a concrete edge forming system that is easy to use in connection with conventional concrete forming techniques and is reusable for multiple concrete placements.

### BRIEF SUMMARY OF THE INVENTION

In this regard, the present invention provides for concrete forming system that is suitable for use in connection with conventional concrete forming materials in order to impart a clean finished appearance to the exposed face and lower exposed edge of a cantilevered concrete slab. The present invention is an extruded forming component that is intended to be installed into a concrete edge form by hanging the extrusion over the edge forming material. The interior surface of the metal extrusion is smooth and includes a radius that extends downwardly and outwardly from the bottom edge thereof. The smooth vertical face of the extrusion and the radiused lower edge cover the inner face of the traditional slab edge form creating a new exposed profile against which the concrete will be placed. The concrete is installed and vibrated as would be traditionally done in the prior art. In the context of the present invention however, the concrete consolidates against the smooth surface of the extrusion and the radiused lower edge. The slab is then finished on its top surface as is normal in the prior art and the top exposed edge is finished using a tool that creates a radiused edge thereon. Once the concrete has hardened sufficiently, the edge form is removed revealing a smooth edge face and a radiused bottom edge that matches the tool finished radius on the top edge of the slab.

In addition, the edge forming system of the present invention also provides inserts that are for use in the interior corners formed by the form panels that are not accessible during the concrete placement until the form panels are removed. As can be appreciated the same condition as exists at the bottom edge of a cantilevered slab also exists at the corners of the slabs and/or walls. The radiused extrusion of the present invention is installed into these interior corners of the form panels to impart a radius to the concrete once it has hardened and the form panels are removed.

It is therefore an object of the present invention to provide a concrete edge forming system that imparts a smooth and clean finish to the face of an exposed concrete slab while also providing a radius for its lower edge. It is a further object of the present invention to provide a concrete edge forming system that imparts a smooth clean finish to the exposed face and the bottom, exposed edge of a cantilevered concrete slab. Finally, it is an object of the present invention to provide a concrete edge forming system that is easy to use in connection with conventional concrete forming techniques and is reusable for multiple concrete placements.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a perspective view of a prior art edge form arrangement used in the prior art and the concrete finish produced thereby;

FIG. 2 is a perspective view of the edge-forming insert of the present invention;

FIG. 3 is a cut-away perspective of the edge-forming insert of the present invention as it is used in a concrete placement;

FIG. 4 is perspective view of a corner insert in accordance with the teachings of the present invention; and

FIG. 5 is a cut-away perspective of the corner insert of the present invention as it is used in a concrete placement.

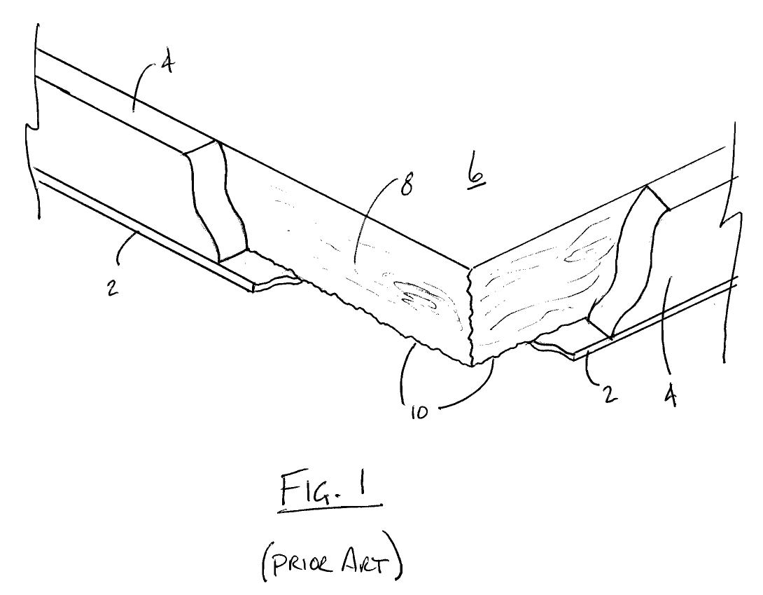

### DETAILED DESCRIPTION OF THE INVENTION

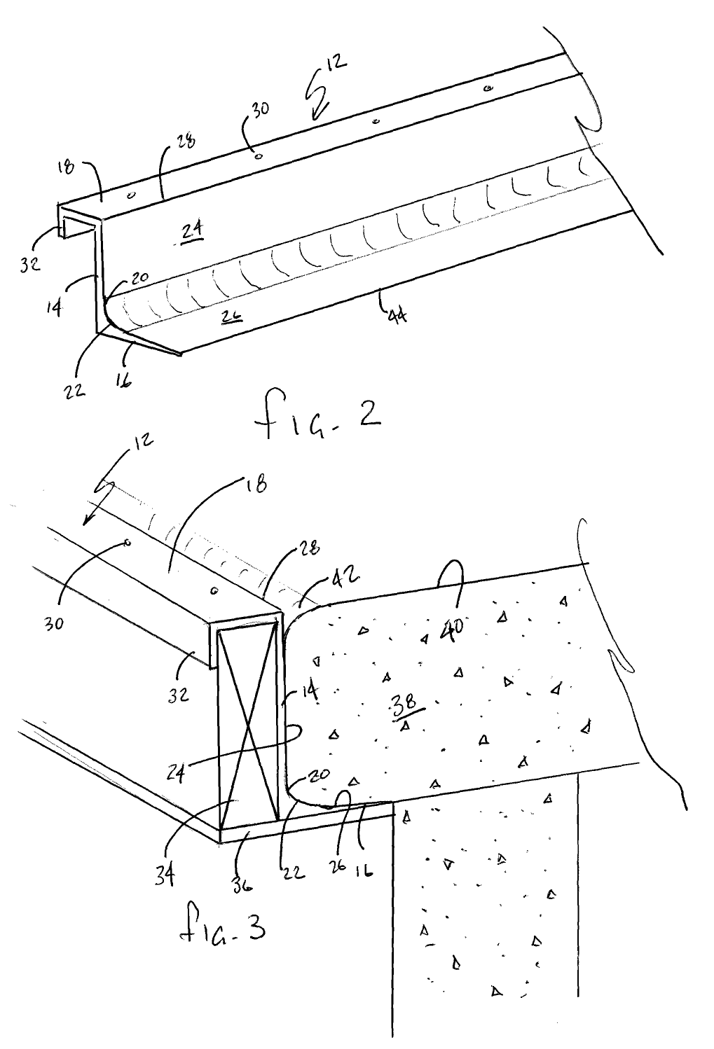

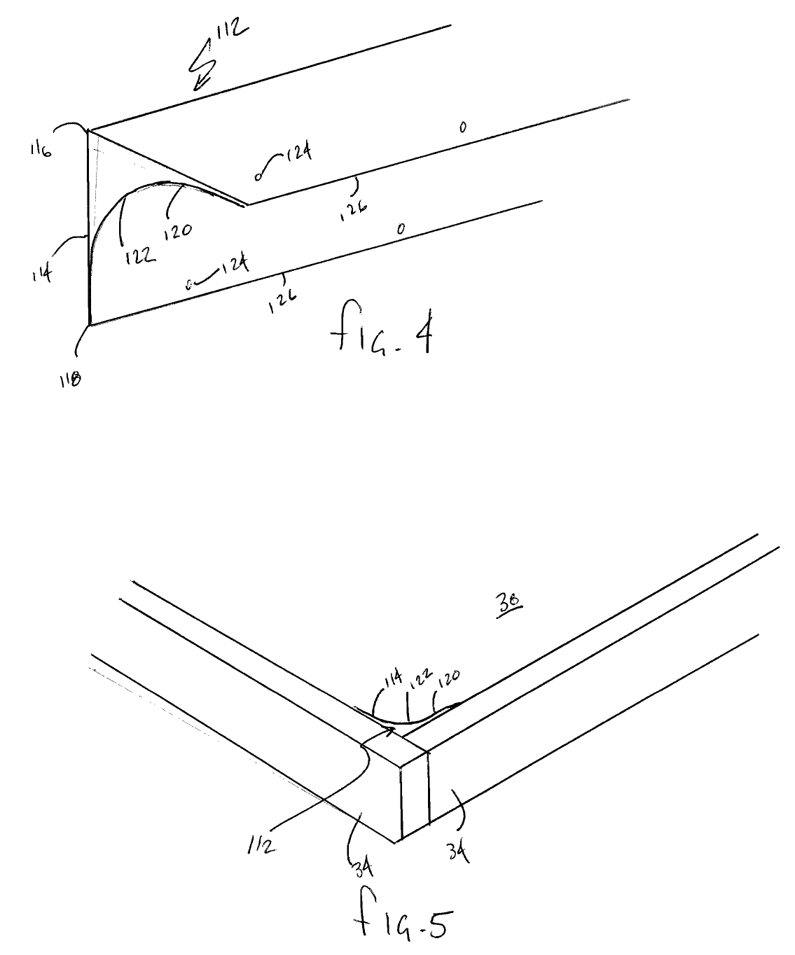

Now referring to the drawings, the concrete edge forming system of the present invention is generally shown in illustrated in FIGS. 2-5 where an edge face and bottom radius configuration is depicted at FIGS. 2 and 3 and a corner configuration is depicted at FIGS. 4 and 5. As can best be seen In FIG. 2, the edge form 12 system of the present invention is a form insert that generally includes a vertical wall 14, a bottom wall 16 and a means for affixing 18 the edge form 12 to a traditional concrete form panel. The vertical wall 14 has a bottom edge 20 that the bottom wall 16 extends inwardly from. The intersection between the bottom wall 16 and the vertical wall 14 is preferably formed as a radius 22 although a rectilinear chamfer would also be suitable for application in the present invention. Preferably, the radius 22 is formed to have a dimension of greater than ½″ and more preferably, the radius 22 will be formed to have a dimension of exactly ½″ although any other radius 22 suitable in the art would be acceptable and fall within the scope of the present invention. It is also preferred that the inner surface 24 of the vertical wall 14 and the top surface 26 of the bottom wall 16 are smooth so that they impart a smooth finish to the concrete as will be described below.

It can be further seen that a means for affixing 18 the edge form 12 system of the present invention is provided at the top edge 28 of the vertical wall 14. The means for affixing 18 the edge form 12 may take numerous forms. In the simplest form the means for affixing the edge form 12 may be an adhesive applied to a rear surface of the vertical wall 14. Optionally, a continuous or intermittent top wall 18 may extend rearwardly from the top edge 28 of the vertical wall 14 such that the top wall 18 or top wall segments extend over the top edge of a concrete form panel, thereby supporting the form insert 12 from the form panel itself. To further facilitate affixing of the edge form 12, holes 30 may be provided in the top wall 18 through which fasteners such as nails or screws may be installed to effectively fasten the edge form 12 to the top of the concrete form panel. Finally, the means for affixing may include a return lip 32 that extends downwardly from the top wall 18 to engage behind the traditional concrete form panel. While specific means for affixing the edge form 12 to the concrete form panel have been disclosed herein, there are certainly other possibilities that exist that have not been discussed yet such means are also intended to fall within the scope of the present invention.

The edge form 12 of the present invention may be made from metal, polymer of a fiber reinforced polymer material and the profile of the edge form 12 may be extruded, rolled, cast or formed. The selection of a suitable material is based on the fact that the concrete edge form 12 of the present invention is intended to have sufficient durability to allow it to be removed once the concrete has cured and then be easily reused.

Turning to FIG. 3, the edge form 12 insert of the present invention is intended to be installed into a concrete form panel 34 by hanging the edge form 12 over the concrete form panel 34 itself. The interior surfaces 24, 26 of the edge form 12 are smooth and include a radius 22 that extends downwardly and outwardly from the bottom edge thereof. The smooth vertical wall 14 of the edge form 12 and the radiused lower wall 16 cover the inner faces of the traditional slab side form panel 34 and bottom form panel 36 creating a new exposed profile against which the concrete will be placed. The concrete 38 is installed and vibrated as would be traditionally done in the prior art. In the context of the present invention however, the concrete 38 consolidates against the smooth surfaces of the vertical wall 14, the bottom wall 16 and the radius 22. The concrete 38 is then finished on its top surface 40 as is normal in the prior art and the top exposed edge 42 is finished using a tool that creates a radiused edge thereon. Once the concrete 38 has hardened sufficiently, the concrete form panels 34, 36 and edge form 12 is removed revealing a smooth edge face and a radiused bottom edge on the concrete 28 that matches the tool finished radius on the top edge 42 of the slab. It can be further seen that the thickness of the bottom wall 16 of the edge form is tapered as it extends from the vertical wall 14 to the interior of the form panel. By tapering the bottom wall 16 in this manner, the terminal edge 44 of the bottom wall 16 is very thin allowing it to have a feathering effect at its terminal edge 44 thereby preventing the formation of a pronounced ridge in the finished concrete material.

Turning now to FIG. 4, the edge forming insert 112 of the present invention is depicted in a corner configuration, wherein the edge form 112 includes a first vertical 114 wall having an interior edge 116 and an exterior edge 118 and a second vertical wall 120 extending outwardly from the interior edge 116 of the first vertical wall 114. Again as stated above, the intersection between the first and second vertical walls 114, 120 is formed as a radius 122. In this embodiment, as best seen in FIG. 5 the edge form 112 insert is configured for installation into an interior corner formed between two form panels 34. In this case, since the finished concrete 38 has a negative image of the form panels 34 into which it is installed, while the edge form 112 insert is installed into an interior corner of the form panels 34 it serves to create a radiused profile on the exterior corner of the concrete 38 formed therein.

Since the edge form 112 in this configuration is received fully within the concrete form panels 34, the means for affixing the edge form 112 are limited to adhesive applied to a rear surface of the first and second vertical walls 114, 120 or fasteners that extend through holes 124 provided in the first and second vertical walls 114, 120. The intersection between the first and second vertical walls 114, 120 is preferably formed as a radius 122 although a rectilinear chamfer would also be suitable for application in the present invention. Preferably, the radius 122 is formed to have a dimension of greater than ½″ and more preferably, the radius 122 will be formed to have a dimension of exactly ½″ although any other radius 122 suitable in the art would be acceptable and fall within the scope of the present invention. It is also preferred that the inner surfaces of the first and second vertical walls 114, 120 are smooth so that they impart a smooth finish to the concrete 38 as will be described below.

This configuration of the edge form 112 insert of the present invention is intended to be installed into an interior corner between two adjacent concrete form panels 34. The interior surface of the edge form 112 is smooth and creates a new exposed profile against which the concrete 38 will be placed. The concrete 38 is installed and vibrated as would be traditionally done in the prior art. In the context of the present invention however, the concrete consolidates against the smooth surfaces of the first and second vertical walls 114, 120 and the radius 122 extending therebetween. Once the concrete 38 has hardened sufficiently, the concrete form panels 34 and edge form 112 is removed revealing a smooth edge face and a radiused corner. It can be further seen that the thickness of the first and second vertical walls 114, 120 is tapered as they extend outwardly from the corner of the form panels. By tapering the thickness of the first and second vertical walls 114, 120 in this manner, the terminal edges 126 of the first and second vertical walls 114, 120 is very thin, allowing them to have a feathering effect at their terminal edge 126 thereby preventing the formation of a pronounced ridge in the finished concrete material 38.

It can therefore be seen that the present invention provides a unique and useful edge forming insert that facilitates the installation of concrete slabs having exposed edges by ensuring that both the exposed face as well as the bottom exposed edge of the concrete slab have a finished appearance when the form panels are removed. Further, the present invention provided a configuration that is useful in ensuring a smooth radiused corner on such monolithic concrete placements as slabs and exposed walls. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A concrete edge form insert comprising:
a vertical wall having a top edge and a bottom edge;
a bottom wall extending inwardly from said bottom edge of said vertical wall, wherein an intersection between said bottom wall and said vertical wall is formed as a radius; and
means for affixing said edge form to a concrete form panel extending rearwardly from said top edge of said vertical wall.

2. The concrete edge form of claim 1, wherein the radius between said bottom wall and said vertical wall has a dimension of ½″ or greater.

3. The concrete edge form of claim 1, wherein said means for affixing said edge form is an adhesive applied to a rear surface of said vertical wall.

4. The concrete edge form of claim 1, wherein said means for affixing said edge form is a top wall extending rearwardly from said top edge of said vertical wall, said top wall having holes therein for receiving fasteners therethrough.

5. The concrete edge form of claim 1, wherein said means for affixing said edge form is a top wall extending rearwardly from said top edge of said vertical wall, said top wall terminating in a return lip configured to engage a top edge of said concrete form panel.

6. The concrete edge form of claim 1, wherein a thickness of said bottom wall is tapered toward its inward edge.

7. The concrete edge form of claim 1, wherein said edge form is made from a material selected from the group consisting of: metal, polymer and fiber reinforced polymer.

8. A concrete edge form insert comprising:
a first vertical wall having an interior edge and an exterior edge;
a second vertical wall extending outwardly from an interior edge of said first vertical wall, wherein an intersection between said first and second vertical walls is formed as a radius; and
means for affixing said edge form to an interior surface of a concrete form.

9. The concrete edge form of claim 8, wherein the radius between said first and second vertical walls has a dimension of ½″ or greater.

10. The concrete edge form of claim 8, wherein said means for affixing said edge form is an adhesive applied to a rear surface of first and second said vertical walls.

11. The concrete edge form of claim 8, wherein a thickness of said first and second vertical walls is tapered towards their outward edges.

12. The concrete edge form of claim 8, wherein said edge form is made from a material selected from the group consisting of: metal, polymer and fiber reinforced polymer.
